(19) United States
(12) Patent Application Publication
(10) Pub. No.: US 2026/0342240 A1
(43) Pub. Date: Oct. 29, 2026

(54) ZERO VOLTAGE SWITCHING MULTILEVEL-ACTIVE-NEUTRAL-POINT CLAMPED CONVERTER

(71) Applicant: HILLCREST ENERGY TECHNOLOGIES LTD., Vancouver (CA)

(72) Inventors: Jalal AMINI, Vancouver (CA); Ari BERGER, Vancouver (CA); Harald HENGSTENBERGER, Landsberg am Lech (DE)

(21) Appl. No.: 19/122,217

(22) PCT Filed: Oct. 20, 2023
(86) PCT No.: PCT/CA2023/051398

§ 371 Date: Apr. 17, 2025

Related U.S. Application Data
(60) Provisional application No. 63/380,342, filed on Oct. 20, 2022.

(51) Int. Cl. H02M 7/797; H02M 1/00; H02M 7/757

(52) U.S. Cl. CPC H02M 7/797; H02M 1/0058; H02M 7/757

(57) ABSTRACT

A bi-directional power converter is disclosed, the power converter comprising: a low-frequency circuit comprising four low-frequency switches and two DC-link capacitors; a high-frequency circuit comprising two high-frequency switches; and an auxiliary circuit comprising two resonance capacitors, two intermediate capacitors, a bi-directional switch electrically connected in series with both the first intermediate capacitor and the second intermediate capacitor, and an inductor electrically connected in series with the bi-directional switch and the AC terminal.

### CROSS-REFERENCE TO RELATED APPLICATIONS

This application claims priority from application No. 63/380342, filed 20 Oct. 2022. For purposes of the United States, this application claims the benefit under 35 U.S.C. § 119 of application No. 63/380342, filed 20 Oct. 2022, and entitled ZERO VOLTAGE SWITCHING MULTILEVEL ACTIVE-NEUTRAL-POINT-CLAMPED CONVERTER which is hereby incorporated herein by reference for all purposes.

### TECHNICAL FIELD

The present disclosure relates to power converters generally and more specifically to a multilevel converter with a soft switching scheme having high power density, high efficiency, and improved performance.

### BACKGROUND

AC/DC and DC/AC Converters play an important role in electric devices such as electrical drives, EVs, renewable energy harvesting systems, grid application, appliances, etc. Their penetration in the power system has been increasing in recent years, and they have started to play an important role in energy conversion systems.

Because of non-idealities in a converter's power switches, there are conduction and switching losses. These losses reduce efficiency and cause the temperature to rise in the power switches. Higher junction temperature reduces the lifetime and the reliability of the switches and puts a restraint on the maximum switching frequency that the converter can run at. The limited switching frequency also hinders the converter's ability to achieve better output power quality, higher power density, and lower cost. Increasing switching frequency leads to better output power quality, and makes passive component smaller which results in a more compact and cost-effective converter. The way to reach higher frequency is to reduce the switching losses to limit junction temperature of the power-switching device. As it is evident, reducing switching losses is of great interest.

Switching losses in power semiconductor devices are the result of the overlapping of rising and falling edges of the voltage over the device with falling and rising edges of the current flowing through the device, respectively. One way to reduce the switching losses is by shortening the overlapping time via increasing rising and falling rates of the current and the voltage. To do so, in recent years, switching devices based on wide-bandgap materials have been introduced to the market. Although they have lower losses compared to silicon-based devices, the full utilization of their advantages is hindered by technical problems like electromagnetic interference (EMI) and packaging restrictions. Furthermore, with converters based on wide bandgap devices, problems related to high rate of change in voltage (dv/dt) may rise in some applications like motor drives.

Another way of reducing switching losses is by reducing the voltage amplitude over power switches. In this case, the energy loss during one switching transition will be lower. To do so, multilevel converters have been developed. These converters also address dv/dt and EMI problems. The effectiveness in addressing these issues depends on the number of levels of the converter. This fact causes some issues such as large volume, high cost, high switching losses in some devices, etc.

Switching losses also can be reduced by zero voltage switching schemes. The auxiliary resonant commutated pole (ARCP) proposed in U.S. Pat. No. 5,047,913 by R. De Doncker et al. reduces switching losses for a two-level converter. In this scheme, the voltage over the switching device turns zero before the switching event, which leads to zero switching losses. However, the required size of inductors and capacitors is rather large, and it requires two extra switches with a blocking voltage of half of the DC link, which degrades the benefits of a soft-switching scheme because of induced volume, cost, and conduction losses. R. Teichmann in U.S. Pat. No. 6,205,040 B1 proposed an ARCP-based multilevel inverter. This scheme suffers from a high number of semiconductors, which increases cost and volume. Furthermore, since a multilevel converters' outlay is complex, some parasitic parameters may hinder this scheme from reaching optimal performance.

J. Li proposed in U.S. pre-grant Publication No. 2012/0218785 A1 another soft-switching multilevel converter. Although this method reduces the number of active power switches, it adds two more diodes and a transformer. Besides, stray capacitance of the transformer may exacerbate the degradation of the performance because of stray parameters.

Therefore, circuits and methods, which address above mentioned problems and limitations, are desirable.

### SUMMARY

The present invention is a bi-directional power converter with a soft-switching scheme and includes a switching method associated with the power converter. The power converter utilizes a minimum number of switches to achieve soft-switching. Reduced switching and conduction losses, higher switching frequency, better power quality, lower EMI problems, and high reliability are some of the benefits offered by the power converter. The hardware of the power converter consists of two parts, a main part, and an auxiliary part, also referred to as the auxiliary circuit. To reduce conduction losses, the main part is divided into two sections, also referred to as two circuits. A low-frequency circuit which switches at an output frequency and consists of power switches that are optimized for minimal conduction losses with a trade-off in switching speed, and a high frequency circuit which consists of fast switches. The auxiliary circuit helps the high-frequency circuit switch at zero voltage and reduces switching losses in the low frequency circuit considerably.

The low-frequency circuit of the power converter comprises four series connected switches (also referred to as low-frequency switches) which are connected to a positive rail, a middle rail and a negative rail of a DC link from a top, a middle and a bottom, respectively. The high-frequency circuit comprises two fast switches (also referred to as high-frequency switches) in series which are connected to two top and bottom middle points of the low-frequency section (also respectively referred to as the first and second low-frequency circuit outputs) from top and bottom, respectively. A middle point of the high-frequency section (also referred to as an AC terminal) is connected to a load. The auxiliary circuit is a three-port section which comprises two switches forming a bidirectional switch, an inductor, and two intermediate capacitors connected between the power converter output (also referred to as the AC terminal) and top and bottom points of the high-frequency section, and it also has two small capacitors each in parallel with each high-frequency switch of the main circuit.

In other embodiments, this converter can be expanded to levels more than three by adding a high-frequency section and an auxiliary circuit per each extra level. A processor controls all three sections based at least in part on a state of each section and synthesizes a reference output voltage with high quality with high reliability while keeping switching losses, EMI, dv/dt minimal.

### BRIEF DESCRIPTION OF THE DRAWINGS

For a better understanding of the embodiment(s) described herein and to show more clearly how the embodiment(s) may be carried into effect, reference will now be made, by way of example only, to the accompanying drawings.

FIG. 1A depicts a circuit schematic of one embodiment of a phase of a three-level zero-voltage zero-current switching converter according to the present disclosure.

FIG. 1B depicts three circuits providing for three phases each of a three-level zero-voltage zero-current switching converter according to the present disclosure.

FIG. 2 shows a reference voltage, a modulation method, and a main switches' firing pulses.

FIG. 3 depicts possible structures of a bi-directional switch.

FIG. 4 depicts time intervals in switching instant of the disclosed power converter.

FIGS. 5A-5E depict an operation sequence and load current flow in the disclosed power converter when switching to a lower state from a higher state.

FIGS. 6A-6E depict an operation sequence and load current flow in the disclosed power converter when switching to a higher state from a lower state.

FIG. 7 depicts an algorithm flowchart for the control of the power converter according to the present disclosure.

FIG. 8 depicts an algorithm flowchart of the high-frequency circuit of the power converter according to the present disclosure.

FIG. 9 depicts the performance of the power converter.

FIG. 10 depicts a switching transition when a load current does not help transition.

Unless otherwise specifically noted, articles depicted in the drawings are not necessarily drawn to scale.

### DESCRIPTION

Multilevel inverters are capable of reaching medium and high voltages using available switches in the market and therefore, have attracted considerable attention and found their way into many applications such as medium voltage drives, grid application, high-voltage direct current (HVDC) devices, and the like. As their application increases in industry, their efficiency, reliability, cost, and performance are becoming more and more important. One of these converters that have become more popular is the active neutral point clamped converter (ANPCC).

Embodiments of the present disclosure increases this converter's efficiency and reliability while improving performance of the converter such as lowering dv/dt and electromagnetic interference (EMI).

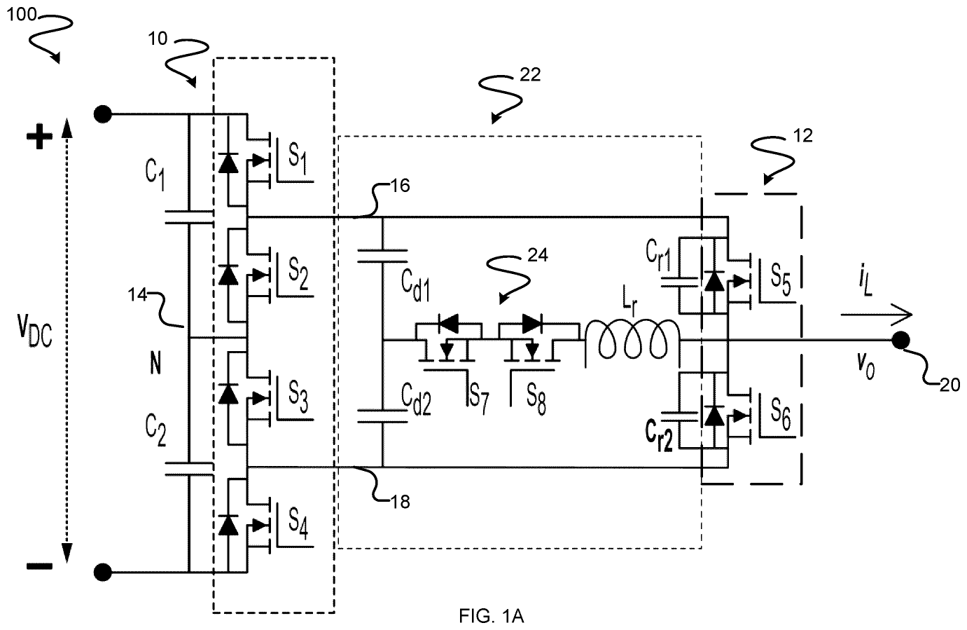

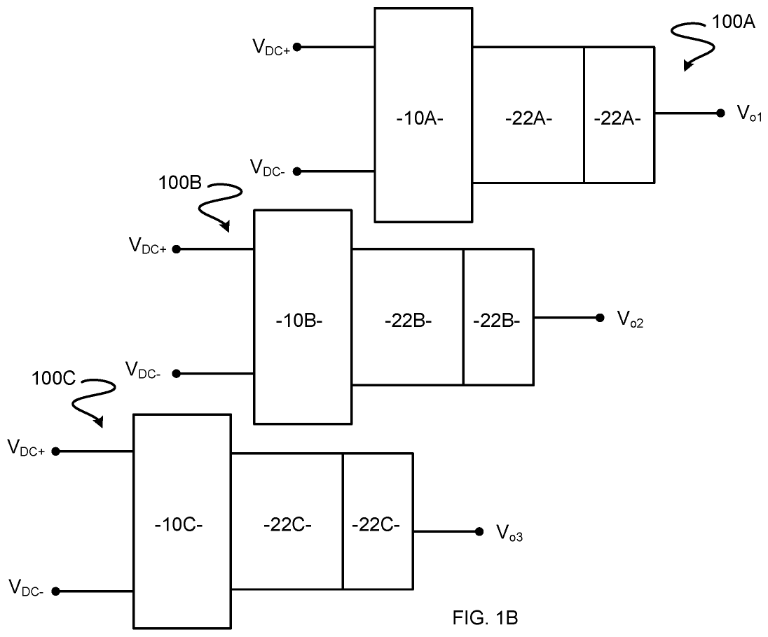

FIG. 1A shows an embodiment of the invention, in the form of three-level soft-switching ANPCC bi-directional power converter 100. Although FIG. 1A depicts a topology of a single-phase power converter, alternative embodiments of the present invention may provide for a power converter with several phases.

Power converter 100 has a main part, which comprises two sets of switches forming low-frequency circuit 10 and high-frequency circuit 12. Low-frequency circuit 10 comprises four reverse-conducting semiconductor switches S1, S2, S3 and S4 connected in series. Switches S1, S2, S3 and S4 may comprise metal-oxide semiconductor field effect transistors (MOSFETs) or insulated gate bipolar transistor (IGBT) with anti-parallel diodes. Switches S1, S2, S3 and S4 switch at a fundamental output frequency. Therefore, in low-frequency circuit 10, low-cost switches optimized for low conduction losses can be utilized. Low-frequency circuit 10 is connected from top, middle and bottom to a positive DC terminal, a neutral terminal, and a negative terminal of a DC-link comprising two DC-link capacitors C1 and C2 connected in series and with middle neutral point 14. To avoid a short-circuit, only one switch from the set S1 and S2, and only one switch from the set S3 and S4 can be turned ON at once. In other words, S1 and S2 should always be in complementary state, and S3 and S4 should also always be in complementary state.

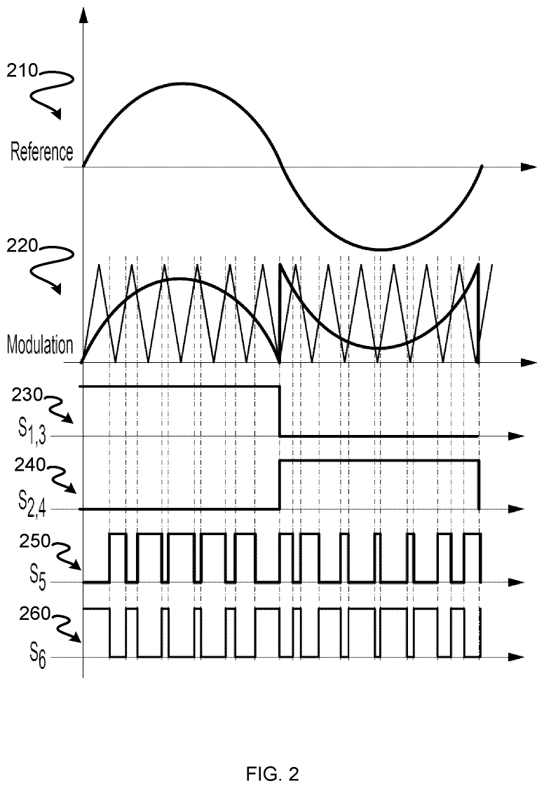

FIG. 2 is a waveform diagram of reference output voltage 210, modulation voltage 220, pulses 230 of switches S1 and S3, pulses 240 of switches S2 and S4, pulse 250 of switch S5, and pulse 260 of switch S6.

As shown in FIG. 2, if a reference output voltage 210 is greater than zero (with respect to middle neutral point 14 of the DC-link), S1 and S3 are ON. If the reference output voltage is less than zero, S2 and S4 are ON. If the reference voltage is zero, to keep switching frequency low, the current switching state will be maintained.

The second set of the switches forming high-frequency circuit 12 comprise two reverse-conducting semiconductor switches with high switching frequency capability in series configuration, S5 and S6, also referred to as the first and second high-frequency switches. S5 and S6 switch at a frequency higher than the fundamental output frequency, for example between 10 times and 100 times the fundamental output frequency. These switches are connected to top middle point (also referred to as first low-frequency circuit output 16) and bottom middle point (also referred to as second low-frequency circuit output 18) of the first sets of the switches from top and bottom, and middle point of this set is connected to an output of the converter, also referred to as AC terminal 20. These two semiconductors switch at high frequency and synthesize a reference output voltage at AC terminal 20. FIG. 2 shows the modulation scheme for these switches. Whenever a modified reference is greater than the triangle waveform, the upper switch (S5) turns ON, otherwise the lower switch (S6) turns ON. It should be mentioned that switches S5 and S6 are always in a complementary state to avoid shoot-through during switching, and an open one of switches S5 and S6 is turned OFF before closed one of switches S5 and S6 is turned ON.

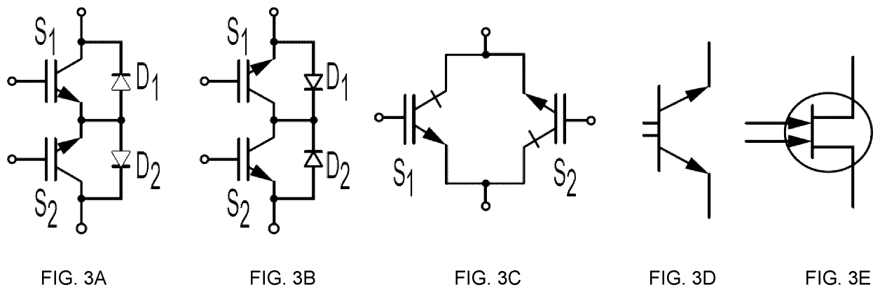

To overcome high switching losses especially in high-frequency circuit 12 and to reduce dv/dt, a third section, auxiliary circuit 22, is added to power converter 100 to provide zero voltage switching capability for high-frequency circuit 12 and to reduce switching losses in low-frequency circuit 10. Auxiliary circuit 22 comprises a bi-directional switch 24, a resonance inductor Lr, two resonance capacitors Cᵣ₁ and Cᵣ₂, and two intermediate capacitors C_{d1} and C_{d2}. As shown in FIGS. 3A to 3E, bi-directional switch 24 may comprise two reverse conduction switches connected in series with common-emitter (FIG. 3A) or common-collector (FIG. 3B) configurations, or alternatively by connecting two reverse-blocking semiconductors in anti-parallel configuration (FIG. 3C), or by using bi-directional semiconductors like B-TRAN™ (FIG. 3D) or Bi-GaN™ (FIG. 3E). Bi-directional switch 24 connects inductor Lᵣ between AC terminal 20 to the middle point of the two intermediate capacitors C_{d1} and C_{d2}. Intermediate capacitors C_{d1} and C_{d2} decouple high frequency circuit 12 from low frequency circuit 10 and mitigate deteriorating effects of the stray inductance of the paths and the connections on the performance of the converter. Auxiliary circuit 22 also has two resonance capacitors Cᵣ₁ and Cᵣ₂ connected in parallel with switches S6 and S5 respectively, of the high frequency section.

Whenever a transition from S5 to S6 or vice versa is needed, and when a load current is not high enough or not in a favorable direction to charge and discharge resonance capacitors Cᵣ₁ and Cᵣ₂ in parallel with switches S5 and S6 according to switching requirements, one of the switches of bidirectional switch 24 of auxiliary circuit 22 turns ON. S8 turns ON when transition from high side to low side required S5 ON to S6 ON, and S7 turns ON when transition required from low side to high side required S6 ON to S5 ON.

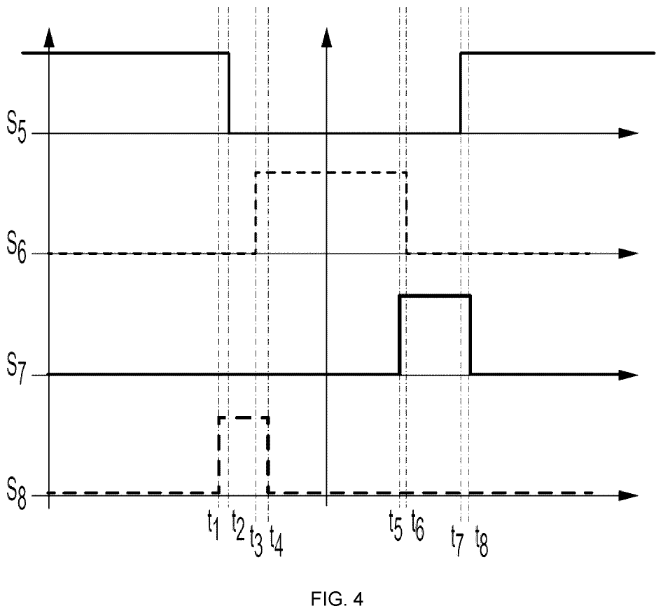

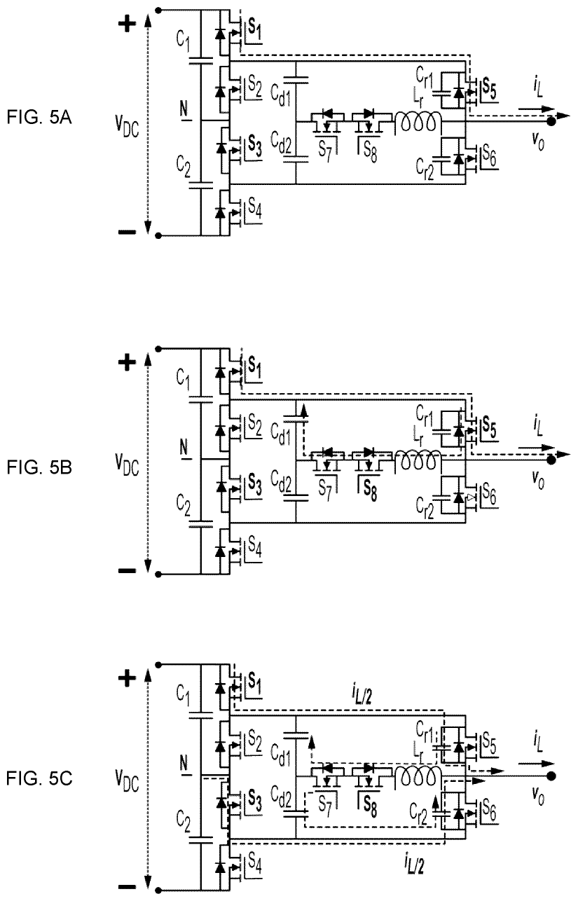

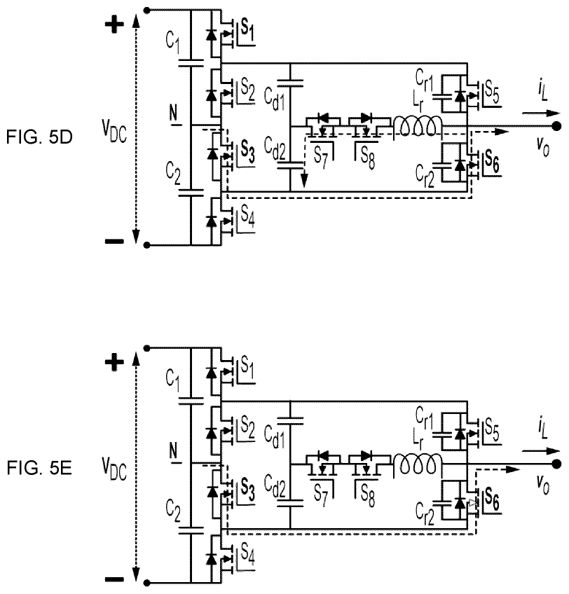

FIG. 4 shows an arrangement of pulses in switches S5, S6, S7 and S8. At a first main switching instant occurrence, a commutation from S5 to S6 is needed. The switching sequence and current direction is shown in FIGS. 5A through 5E, without loss of generality and for the purpose of the following example. In FIGS. 5A-5E, ON switches are shown with bold font. To do the required commutation, at time t₁, shown in FIG. 4, S8 of the auxiliary circuit will be fired before turning S5 OFF at t₂. Overlap between S5 and S8 pulses will charge the resonance inductor in the auxiliary circuit, as shown in FIG. 5B. The amount of the energy needed to be charged into inductor is determined by a load current and circuit components, and is controlled by the time t₂-t₁. When sufficient energy is charged into inductor Lᵣ, S5 will turn OFF at t₂ with zero voltage over it. As shown in FIG. 5C, in the time interval t₂-t₃, a load current and an inductor current will pass through resonance capacitors Cᵣ₁ and Cᵣ₂, and will thereby respectively charge and discharge resonance capacitors Cᵣ₁ and Cᵣ₂. When Cᵣ₂ is fully discharged at t₃, S6 will turn ON at zero voltage. From t₃ to t₄, as shown in FIG. 5D there is an overlap between S8 and S6 which leads to the energy stored in inductor Lᵣ being returned back to the DC link. When the energy stored in the inductor is returned back to the DC link and its current drops to zero, S8 will turn OFF with zero current switching scheme at t₄, and commutation will be completed as shown in FIG. 5E. If the load current is positive as shown in FIGS. 5A-5E, the load current is in favor of the charging and discharging requirement of resonance capacitors Cᵣ₁ and Cᵣ₂ for this commutation; therefore, if the load current is high enough, there is no need to fire the auxiliary circuit's switch, and zero voltage switching will be done only by providing enough time (time interval between turning S5 OFF and S6 ON, known as deadtime) for the load current to fully discharge and charge the associated resonance capacitors.

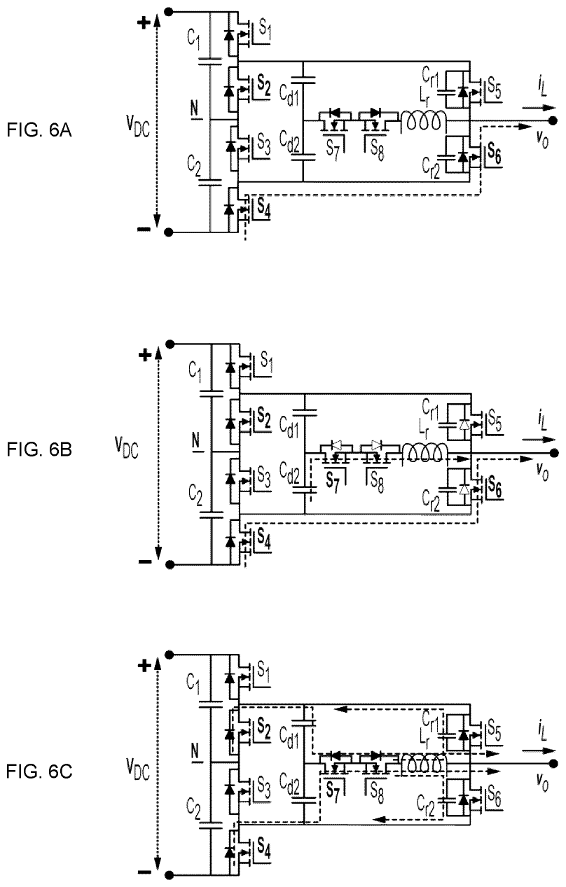

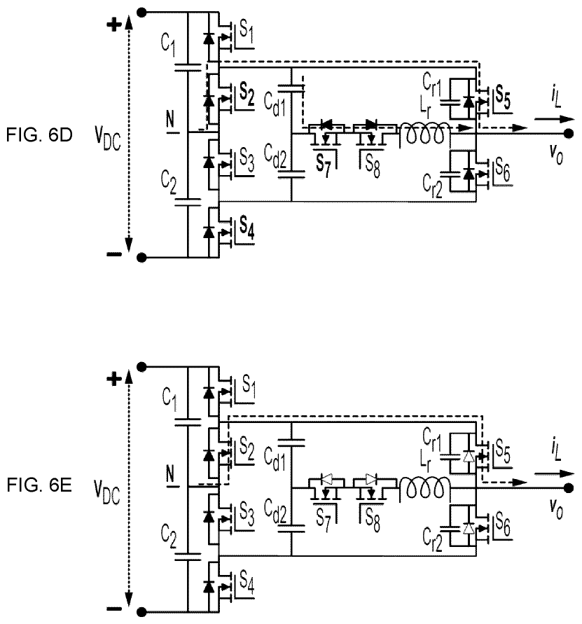

In a second main switching instant (t₅ to tₐ) shown in FIG. 4, a commutation from S6 to S5 is needed. To do this commutation with minimum losses, S7 of the auxiliary circuit will be fired, at t₅. An overlap between S6 and S7 ON states will charge resonance inductor Lr in the auxiliary circuit, as shown in FIG. 6B. The amount of the energy needed to be charged into inductor Lr is determined by the load current and the circuit components. Since the load current is not in favor of the commutation, the amount of the inductor current will be higher than in the example depicted in FIGS. 5A-5E. When enough energy is charged into inductor Lᵣ, S6 will turn OFF at t₆ with zero voltage over it. As shown in FIG. 6C, in the time interval t₆-t₇, the inductor current provides the load current and the rest of the current will pass through resonance capacitors Cᵣ₂ and Cri and thereby respectively charge and discharge Cᵣ₂ and Cᵣ₁. When Cᵣ₁ is fully discharge at t₇, S5 will turn ON at zero voltage. From t₇ to t₈, there is an overlap between S7 and S5 which leads to the energy stored in inductor Lᵣ to be returned back to the DC link. When the energy stored in the inductor is returned back to the DC link and its current drops to zero, S7 will turn OFF at t₈, and commutation will be completed as shown in FIG. 6E. Since the load current is positive as shown in FIG. 6, the load current is not in favor of the charging and discharging requirement for this commutation, and the auxiliary circuit needs to divert the load current from the main switches. Therefore, the auxiliary circuit is required to achieve voltage switching.

With negative load current, opposite to above example, the load current is not in favor of the commutation from S5 to S6 but is in favor of the commutation from S6 to S5; therefore, there will be complementary condition.

Switching in the low-frequency section (also referred to as the low-frequency circuit) occur in zero crossing of the reference voltage. With high load power factor, lower switching losses occur in this section with minimum equal to zero switching losses at power factor equal to one (1). Furthermore, during the deadtime, the load current is divided between the upper rail and the lower rail of the high frequency section and is drawn from the higher and the lower middle point of the low-frequency section (also referred to as the first and second low-frequency circuit outputs). Therefore, if any required switching in the low-frequency section is done in this interval, the switching losses will be almost half of the switching losses when switching is done at other times. To be concise, if commutation is required in low-frequency section it will take place during next commutation in high-frequency section. FIGS. 5-c and 6-c show examples of the switching sequence and current path during commutation with positive load current when a commutation in low-frequency section is needed.

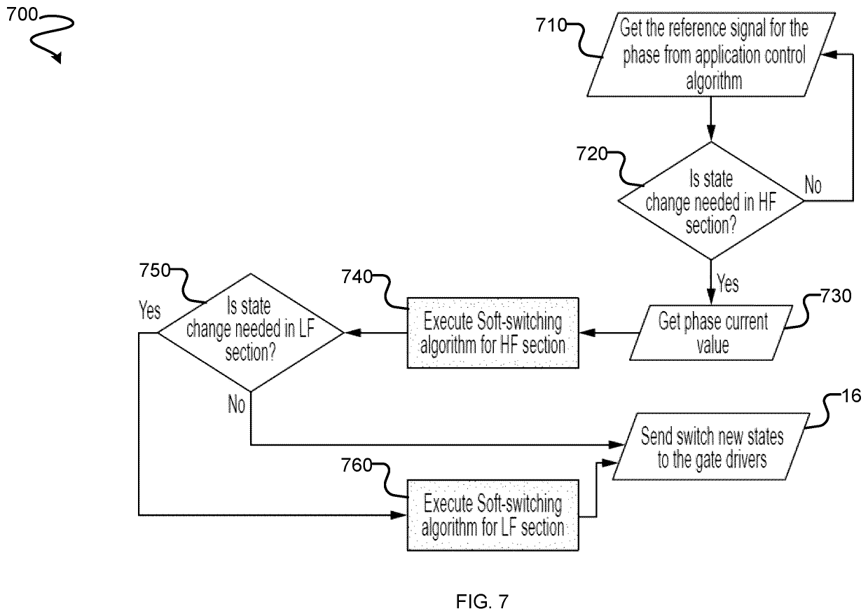

FIG. 7 shows a flow chart of a control system for controlling the power converter. Flowchart 700 summarizes the operation of the inverter-level controller and can be implemented in any type of processing unit. After getting reference signal 710, it is determined whether a switch state change is needed in the high frequency section. Afterwards, after getting load current value 730, a soft switching algorithm is run for high-frequency section 740. If a switching state change is also needed for low-frequency section, it will be done during deadtime of the zero-voltage switching algorithm for high-frequency section. At the end new switching states will be sent to gate drivers in couple of intervals 770.

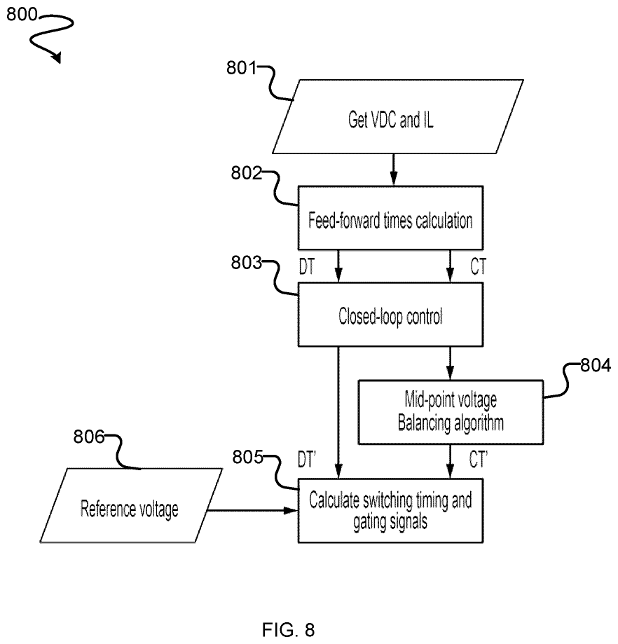

Soft-switching algorithm for high-frequency (HF) section 740 can be implement in open-loop or closed-loop structures. In open-loop structure the deadtime, when load current is in favor of the soft switching, is calculated as DT=2CᵣV_{DC}/I_{L}2*Cᵣ*V_{DC}/I_{L}, and when load current is not in favor of soft switching the deadtime will be equal to DT=2π\sqrt{2LᵣCᵣ} and charging time, the overlap of the auxiliary switch ON state with ON state of the main switch will be CT=2Lᵣi_{L}/V_{DC}. In some embodiment, to compensate the system losses, some extra time will be added to the charging time. However, the open-loop method is not able to compensate system non-linearities and parameter deviation because of working and environment conditions like temperature, load behavior, etc. Therefore, a closed-loop method is developed for controlling HF section. FIG. 8 shows this algorithm. In this method, after getting DC voltage and load current values, deadtime and charging time are calculated by open-loop formulas 802. This forms a feedforward loop in the control system and enhance its response time and performance. Afterwards, the closed-loop algorithm 803 compensates any error in soft switching including partial hard switching or extra charge by using various sensors which may include, but not limited to, dv/dt sensors, zero voltage detection, and gate sensors to calculate timing errors. In the next step, Intermediate capacitor voltage balancing method 804 regulates the intermediate capacitor voltages by modifying appropriate charging time. The switching timing based on deadtime, charging time and reference voltage is calculated in 805. This switching timing will be used in 770. If a switching is needed in LF section, using the switching timing provided by 740, block 760 makes sure that the transition is done in the deadtime of the HF section.

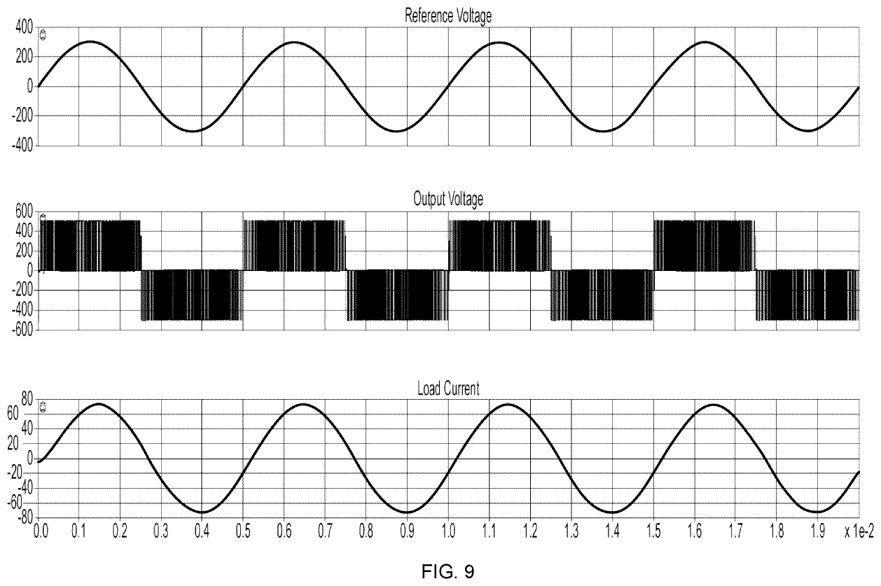

FIG. 9 shows performance of half-bridge configuration of this converter. In this figure, the reference voltage is shown on top. The middle waveform is the synthesized reference voltage on converter output. As it is depicted, this waveform has 3 levels which has better quality compared to conventional 2-level converters. Load current is shown at the bottom.

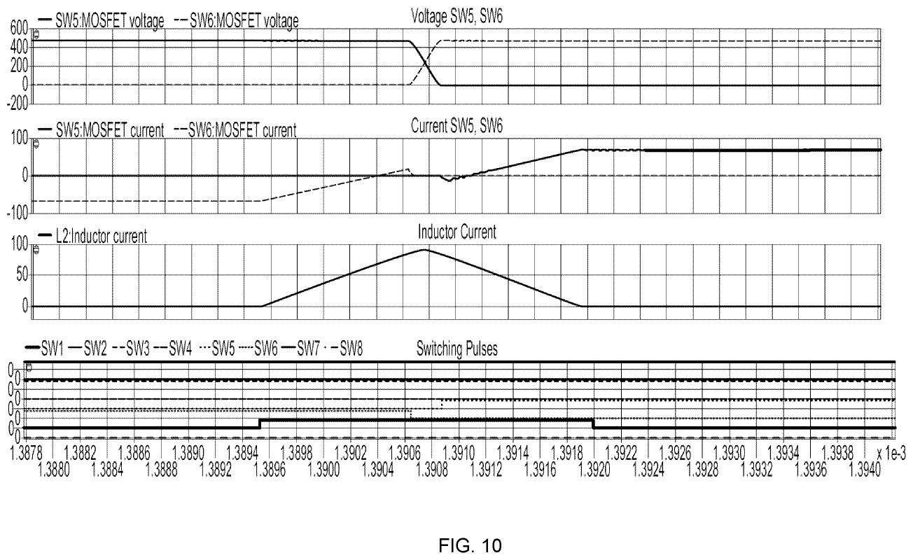

FIG. 10 shows the switching interval. The voltage transitions of S5 and S6 are shown at top. Below that, the currents of these two switches are shown. As it is depicted, during voltage transitions of the switches switch current is zero which translates to zero switching losses. The resonance inductor's current is shown next, and at the bottom the switching timing is shown.

The disclosed invention offers a very high-efficient power conversion with improved efficiency, power quality and EMI problems. It has advantages of having lower dv/dt compared to hard-switching multilevel inverters, regardless of their structures, and a lower number of switches compared to other scheme of soft-switching multilevel inverters.

### SOME EMBODIMENTS

FIG. 1B depicts an embodiment of the present invention comprising three power converters 100A, 100B, 100C providing for three phases each of a three-level zero-voltage zero-current switching converter according to the present disclosure.

In one or more embodiments of the invention:
one or more of the first, second, third, and fourth low-frequency switches switch at a frequency between 0.1 Hz and 1 k Hz;
one or both of the first and second high-frequency switches switch at a frequency between 5 kHz and 100 kHz;
one or both of the first and second DC-link capacitors have a capacitance is 100 uF;
one or both of the first and second resonance capacitors have a capacitance between 5 nF;
one or both of the first and second intermediate capacitors have a capacitance between 10 uF;
the inductor has an inductance is 3 uH;
the DC voltage is between 400-1500V; and/or
the AC voltage is between 208-690V.

In some embodiments of the invention, high-frequency switches S5 and S6 switch between ON and OFF at a high-frequency, and low-frequency switches S1, S2, S3 and S4 switch between ON and OFF at a low-frequency, wherein the high-frequency is at least 10 times the low-frequency.

One aspect of the invention provides a bi-directional power converter for converting between a direct current (DC) voltage and an alternating current (AC) voltage, the power converter comprising: a low-frequency circuit comprising: a first low-frequency switch electrically connected between a positive DC voltage terminal and a first low-frequency circuit output; a second low-frequency switch electrically connected between the first low-frequency circuit output and a neutral point; a third low-frequency switch electrically connected between the neutral point and a second low-frequency circuit output; a fourth low-frequency switch electrically connected between the second low-frequency circuit output and a negative DC voltage terminal; a first DC-link capacitor electrically connected between the positive DC voltage terminal and the neutral point; a second DC-link capacitor electrically connected between the negative DC voltage terminal and the neutral point; a high-frequency circuit comprising: a first high-frequency switch electrically connected between the first low-frequency circuit output and an AC terminal; a second high-frequency switch electrically connected between the second low-frequency circuit output and the AC terminal; an auxiliary circuit comprising: a first resonance capacitor electrically connected in parallel with the first high-frequency switch; a second resonance capacitor electrically connected in parallel with the second high-frequency switch; a first intermediate capacitor and a second intermediate capacitor electrically connected in series between the first low-frequency circuit output and the second first low-frequency circuit output; a bi-directional switch electrically connected in series with both the first intermediate capacitor and the second intermediate capacitor; and an inductor electrically connected in series with the bi-directional switch and the AC terminal.

In one or more embodiments of the power converter:
the positive DC terminal and the negative DC terminal are electrically connected to a DC power source, and the AC power terminal is electrically connected to a load;
the AC power terminal is electrically connected to a power source, and the positive DC terminal and the negative DC terminal are electrically connected to a load;
the first high-frequency switch and the second high-frequency switch each comprise a silicon semiconductor switch;
one or more of the silicon semiconductor switches comprise a wide-bandgap switch;
the first high-frequency switch and the second high-frequency switch each comprise either a metal-oxide-semiconductor field-effect transistor (MOSFET) or an insulated-gate bipolar transistor (IGBT);
the first low-frequency switch, the second low-frequency switch, the third low-frequency switch, and the fourth low-frequency switch, each comprise a silicon semiconductor switch;
the first low-frequency switch, the second low-frequency switch, the third low-frequency switch, and the fourth low-frequency switch, each comprise one of: a metal-oxide-semiconductor field-effect transistor (MOSFET), an insulated-gate bipolar transistor (IGBT), or an integrated gate-commutated thyristor (IGCT);
the bi-directional switch comprises two anti-paralleled reverse-blocking switches;
the bi-directional switch comprises: a first switch and a second switch electrically connected in series; a first diode electrically connected in anti-parallel with the first switch; and a second diode electrically connected in anti-parallel with the second switch; and/or
the bi-directional switch comprises one or more silicon-carbide (SIC) switch and/or one or more gallium nitride (GaN) switch.
In one or more embodiments of the power converter:

One aspect of the invention provides a control system for controlling the power converter connected to a DC power source and an AC load, wherein the load has a load voltage and a load current measured at the AC power terminal, and the control system switches one or more of: the first low-frequency switch, the second low-frequency switch, the third low-frequency switch, the fourth low-frequency, the first high-frequency switch, the second high-frequency switch, and the bi-directional switch; based at least in part on the load current and the load voltage.

One aspect of the invention provides a control system for controlling the power converter connected to an AC power source and a DC load wherein the load has a load voltage and a load current measured at the positive DC terminal, and the control system switches one or more of: the first low-frequency switch, the second low-frequency switch, the third low-frequency switch, the fourth low-frequency, the first high-frequency switch, the second high-frequency switch, and the bi-directional switch; based at least in part on the load current and the load voltage.

In one or more embodiments of the control system:
the control system simultaneously switches two or more of: the first high-frequency switch, the second high-frequency switch, and the bi-directional switch;
the control system switches one or more of: the first high-frequency switch, the second high-frequency switch, and the bi-directional switch; based at least in part on the load current direction;

In one or more embodiments of the control system: the first DC-link capacitor has a first voltage; the second DC-link capacitor has a second voltage; the first intermediate capacitor has a third voltage; the second intermediate capacitor has a fourth voltage; and the control system switches one or more of: the first low-frequency switch, the second low-frequency switch, the third low-frequency switch, the fourth low-frequency, the first high-frequency switch, the second high-frequency switch, and the bi-directional switch, based at least in part on one of more of the first voltage, the second voltage, the third voltage, and the fourth voltage.

Some embodiments of the power converter comprise one or more further high-frequency circuits and auxiliary circuits.

### INTERPRETATION OF TERMS

Unless the context clearly requires otherwise, throughout the description and the claims:
“comprise”, “comprising”, and the like are to be construed in an inclusive sense, as opposed to an exclusive or exhaustive sense; that is to say, in the sense of “including, but not limited to”;
“connected”, “coupled”, or any variant thereof, means any connection or coupling, either direct or indirect, between two or more elements; the coupling or connection between the elements can be physical, logical, or a combination thereof;
“herein”, “above”, “below”, and words of similar import, when used to describe this specification, shall refer to this specification as a whole, and not to any particular portions of this specification;
“or”, in reference to a list of two or more items, covers all of the following interpretations of the word: any of the items in the list, all of the items in the list, and any combination of the items in the list;
the Singular Forms “a”, “an”, and “the” also include the meaning of any appropriate plural Forms.

Embodiments of the invention may be implemented using specifically designed hardware, configurable hardware, programmable data processors configured by the provision of software (which may optionally comprise “firmware”) capable of executing on the data processors, special purpose computers or data processors that are specifically programmed, configured, or constructed to perform one or more steps in a method as explained in detail herein and/or combinations of two or more of these. Examples of specifically designed hardware are: logic circuits, application-specific integrated circuits (“ASICs”), large scale integrated circuits (“LSIs”), very large scale integrated circuits (“VLSIs”), and the like. Examples of configurable hardware are: one or more programmable logic devices such as programmable array logic (“PALs”), programmable logic arrays (“PLAs”), and field programmable gate arrays (“FPGAs”)). Examples of programmable data processors are: microprocessors, digital signal processors (“DSPs”), embedded processors, graphics processors, math co-processors, general purpose computers, server computers, cloud computers, mainframe computers, computer workstations, and the like. For example, one or more data processors in a control circuit for a device may implement methods as described herein by executing software instructions in a program memory accessible to the processors.

For example, while processes or blocks are presented in a given order, alternative examples may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed in parallel, or may be performed at different times.

In addition, while elements are at times shown as being performed sequentially, they may instead be performed simultaneously or in different sequences. It is therefore intended that the following claims are interpreted to include all such variations as are within their intended scope.

Software and other modules may reside on servers, workstations, personal computers, tablet computers, image data encoders, image data decoders, PDAs, color-grading tools, video projectors, audio-visual receivers, displays (such as televisions), digital cinema projectors, media players, and other devices suitable for the purposes described herein. Those skilled in the relevant art will appreciate that aspects of the system can be practised with other communications, data processing, or computer system configurations, including: Internet appliances, hand-held devices (including personal digital assistants (PDAs)), wearable computers, all manner of cellular or mobile phones, multi-processor systems, microprocessor-based or programmable consumer electronics (e.g., video projectors, audio-visual receivers, displays, such as televisions, and the like), set-top boxes, color-grading tools, network PCs, mini-computers, mainframe computers, and the like.

The invention may also be provided in the form of a program product. The program product may comprise any non-transitory medium which carries a set of computer-readable instructions which, when executed by a data processor, cause the data processor to execute a method of the invention. Program products according to the invention may be in any of a wide variety of forms. The program product may comprise, for example, non-transitory media such as magnetic data storage media including floppy diskettes, hard disk drives, optical data storage media including CD ROMs, DVDs, electronic data storage media including ROMs, flash RAM, EPROMs, hardwired or preprogrammed chips (e.g., EEPROM semiconductor chips), nanotechnology memory, or the like. The computer-readable signals on the program product may optionally be compressed or encrypted.

Where a component (e.g. a switch, capacitor, inductor, device, circuit, etc.) is referred to above, unless otherwise indicated, reference to that component (including a reference to a “means”) should be interpreted as including as equivalents of that component any component which performs the function of the described component (i.e., that is functionally equivalent), including components which are not structurally equivalent to the disclosed structure which performs the function in the illustrated exemplary embodiments of the invention.

Specific examples of systems, methods and apparatus have been described herein for purposes of illustration. These are only examples. The technology provided herein can be applied to systems other than the example systems described above. Many alterations, modifications, additions, omissions, and permutations are possible within the practice of this invention. This invention includes variations on described embodiments that would be apparent to the skilled addressee, including variations obtained by: replacing features, elements and/or acts with equivalent features, elements and/or acts; mixing and matching of features, elements and/or acts from different embodiments; combining features, elements and/or acts from embodiments as described herein with features, elements and/or acts of other technology; and/or omitting combining features, elements and/or acts from described embodiments.

Various features are described herein as being present in “some embodiments”. Such features are not mandatory and may not be present in all embodiments. Embodiments of the invention may include zero, any one or any combination of two or more of such features. This is limited only to the extent that certain ones of such features are incompatible with other ones of such features in the sense that it would be impossible for a person of ordinary skill in the art to construct a practical embodiment that combines such incompatible features. Consequently, the description that “some embodiments” possess feature A and “some embodiments” possess feature B should be interpreted as an express indication that the inventors also contemplate embodiments which combine features A and B (unless the description states otherwise or features A and B are fundamentally incompatible).

It is therefore intended that the following appended claims and claims hereafter introduced are interpreted to include all such modifications, permutations, additions, omissions, and sub-combinations as may reasonably be inferred. The scope of the claims should not be limited by the preferred embodiments set forth in the examples, but should be given the broadest interpretation consistent with the description as a whole.

Unless defined otherwise, all technical and scientific terms used herein have the same meaning as is commonly understood by one of ordinary skill in the art to which the subject matter disclosed herein belongs. In addition, any citation of references herein is not to be construed nor considered as an admission that such references are prior art to the subject matter disclosed herein.

1. A bi-directional power converter for converting between a direct current (DC) voltage and an alternating current (AC) voltage, the power converter comprising:
a low-frequency circuit comprising: a first low-frequency switch electrically connected between a positive DC voltage terminal and a first low-frequency circuit output;
a second low-frequency switch electrically connected between the first low-frequency circuit output and a neutral point;
a third low-frequency switch electrically connected between the neutral point and a second low-frequency circuit output;
a fourth low-frequency switch electrically connected between the second low-frequency circuit output and a negative DC voltage terminal;
a first DC-link capacitor electrically connected between the positive DC voltage terminal and the neutral point;
a second DC-link capacitor electrically connected between the negative DC voltage terminal and the neutral point; a high-frequency circuit comprising:
a first high-frequency switch electrically connected between the first low-frequency circuit output and an AC terminal;
a second high-frequency switch electrically connected between the second low-frequency circuit output and the AC terminal;
an auxiliary circuit comprising: a first resonance capacitor electrically connected in parallel with the first high-frequency switch;
a second resonance capacitor electrically connected in parallel with the second high-frequency switch;
a first intermediate capacitor and a second intermediate capacitor electrically connected in series between the first low-frequency circuit output and the second first low-frequency circuit output;
a bi-directional switch electrically connected in series with both the first intermediate capacitor and the second intermediate capacitor; and
an inductor electrically connected in series with the bi-directional switch and the AC terminal.

2. The power converter of claim 1, wherein the positive DC terminal and the negative DC terminal are electrically connected to a DC power source, and the AC power terminal is electrically connected to a load.

3. The power converter of claim 1, wherein the AC power terminal is electrically connected to a power source, and the positive DC terminal and the negative DC terminal are electrically connected to a load.

4. The power converter of claim 1, wherein each of the first high-frequency switch and the second high-frequency switch comprises a silicon semiconductor switch.

5. The power converter of claim 4, wherein each silicon semiconductor switch comprises a wide-bandgap switch.

6. The power converter of claim 1, to wherein each of the first high-frequency switch and the second high-frequency switch comprises any one of a metal-oxide semiconductor field-effect transistor (MOSFET) and an insulated-gate bipolar transistor (IGBT).

7. The power converter of claim 1, wherein each of the first low-frequency switch, the second low-frequency switch, the third low-frequency switch, and the fourth low-frequency switch, comprises a silicon semiconductor switch.

8. The power converter of claim 7, wherein each silicon semiconductor switch comprises a wide-bandgap switch.

9. The power converter of claim 1, wherein each of the first low-frequency switch, the second low-frequency switch, the third low-frequency switch, and the fourth low-frequency switch, comprises one of: a metal-oxide-semiconductor field-effect transistor (MOSFET), an insulated-gate bipolar transistor (IGBT), or an integrated gate-commutated thyristor (IGCT).

10. The power converter of claim 1, wherein the bi-directional switch comprises two anti-paralleled reverse-blocking switches.

11. The power converter of claim 1, wherein the bi-directional switch comprises: a first switch and a second switch electrically connected in series; a first diode electrically connected in anti-parallel with the first switch; and a second diode electrically connected in anti-parallel with the second switch.

12. The power converter of claim 11, wherein each of the first switch and the second switch comprises a silicon semiconductor switch.

13. The power converter of claim 12, wherein each silicon semiconductor switch comprises a wide-bandgap switch.

14. The power converter of claim 13, wherein each silicon semiconductor switch comprises a silicon-carbide (SiC) switch or a gallium nitride (GaN) switch.

15. A control system for controlling the power converter of claim 2, wherein the load has a load voltage and a load current measured at the AC power terminal, and the control system switches one or more of: the first low-frequency switch, the second low-frequency switch, the third low-frequency switch, the fourth low-frequency, the first high-frequency switch, the second high-frequency switch, and the bi-directional switch; based at least in part on the load current and the load voltage.

16. A control system for controlling the power converter of claim 3, wherein the load has a load voltage and a load current measured at the positive DC terminal, and the control system switches one or more of: the first low-frequency switch, the second low-frequency switch, the third low-frequency switch, the fourth low-frequency, the first high-frequency switch, the second high-frequency switch, and the bi-directional switch; based at least in part on the load current and the load voltage.

17. The control system of claim 15, wherein the control system simultaneously switches two or more of: the first high-frequency switch, the second high-frequency switch, and the bi-directional switch.

18. The control system of claim 15, wherein load current has a load current direction detector, and the control system switches one or more of: the first high-frequency switch, the second high-frequency switch, and the bi-directional switch; based at least in part on the load current direction.

19. The control system of claim 15 wherein: the first DC-link capacitor has a first voltage; the second DC-link capacitor has a second voltage; the first intermediate capacitor has a third voltage; the second intermediate capacitor has a fourth voltage; and 21 the control system switches one or more of: the first low-frequency switch, the second low-frequency switch, the third low-frequency switch, the fourth low frequency, the first high-frequency switch, the second high-frequency switch, and the bi-directional switch, based at least in part on one of more of the first voltage, the second voltage, the third voltage, and the fourth voltage.

20. The power converter of claim 1, further comprising one or more further high frequency circuits and auxiliary circuits
